(19) United States
(12) Patent Application Publication
(10) Pub. No.: US 2012/0162244 A1
(43) Pub. Date: Jun. 28, 2012

(54) IMAGE SEARCH COLOR SKETCH FILTERING

(75) Inventors: YUE MA, Bellevue, WA (US); JUSTIN DAVID Hamilton, Bellevue, WA (US); Gong Cheng, Beijing (CN); Jingdong Wang, Beijing (CN)

(73) Assignee: MICROSOFT CORPORATION, Redmond, WA (US)

(21) Appl. No.: 12/980,071

(22) Filed: Dec. 28, 2010

(51) Int. Cl. G09G 5/02; G06K 9/68

(52) U.S. Cl. 345/594; 382/218

(57) ABSTRACT

Visual features of images are translated into visual words defined by a dictionary. The visual words are indexed and the images are stored in an image store. A sketched imaged, translated into visual words, is utilized to search for similar images in the image store. The visual words are compared to visual words in the index to identify matches associated with stored images. The stored images are displayed and ranked according to the highest number of matches. Textual searches are used to supplement or refine the search results.

### BACKGROUND

Various methods for search and retrieval of information, such as by a search engine over a wide area network, are known in the art. Such methods typically employ text-based searching. Text-based searching employs a search query that comprises one or more textual elements such as words or phrases. The textual elements are compared to an index or other data structure to identify documents such as web pages that include matching or semantically similar textual content, metadata, file names, or other textual representations.

The known methods of text-based searching work relatively well for text-based documents, however they are difficult to apply to image files. In order to search image files via a text-based query the image file is associated with one or more textual elements, such as a title, file name, or other metadata or tags. The search engines and algorithms employed for text-based searching cannot search image files based on the content of the image and thus, are limited to identifying search result images based only on the data associated with the images.

Methods for content-based searching of images have been developed that analyze the content of an image to identify visually similar images. However, such methods require significant overhead to process such a search because complicated algorithms and statistical analyses are used each time a search is performed to identify potential matches.

### SUMMARY

Embodiments of the present invention relate to systems, methods, and computer-readable media for, among other things, translating images into visual words. In this regard, embodiments of the present invention translate visual features of a sketched image into visual words to identify stored images with similar visual features that are associated with similar visual words. An index of the visual words includes a reference to the associated stored images. A dictionary is comprised of definitions for a plurality of visual words that are used to describe the visual features of both the stored images and the sketched images. A textual search, in connection with the visual word search, may also be used to identify similar images. Once the sketched image is translated into visual words, the index is searched to identify stored images associated with similar visual words. The identified stored images are ranked and displayed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 schematically shows a network environment suitable for performing embodiments of the invention.

FIG. 3 is a flow diagram showing a method for identifying a stored image matched to visual words associated with a sketched image, in accordance with an embodiment of the present invention;

FIG. 4 is a flow diagram showing a method creating an index of visual words associated with a plurality of images, in accordance with an embodiment of the present invention;

FIG. 5 is a flow diagram showing a method for identifying and displaying an image matched to user created image visual words, in accordance with an embodiment of the present invention; and

FIG. 6 is an illustrative screen display showing a sketched image and stored images with similar visual features, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following definitions are used to describe aspects of performing a visual word search. A visual word is a description of a visual feature associated with an image. The visual words are selected from a dictionary with pre-defined visual words corresponding to visual features of an image. Visual features can include portions of an image identified as being distinctive, such as portions of an image that have contrasting intensity or portions of an image that correspond to a particular shape. Visual features also include colors, shapes, sizes, and position. A keyword refers to a conventional text-based search term. A keyword can refer to one or more words that are used as a single term for identifying a document responsive to a query. A responsive result refers to any image that is identified as relevant to a search query based on selection and/or ranking performed by a search engine. When a responsive result is displayed, the responsive result can be displayed by displaying the image itself, or by displaying a thumbnail of the image.

Embodiments of the present invention relate to systems, methods, and computer storage media having computer-executable instructions embodied thereon that translate images into visual words. In this regard, embodiments of the present invention perform a proces sing-friendly, content based image search. The search is performed by translating a sketched image into visual words. Similar stored images are identified based on visual features of the stored images that have also been translated into visual words associated with the stored images. Accordingly, a user searching for a particular image sketches the image, without any understanding of the specific visual words describing various visual features of the sketched image. The user receives search results of stored images with similar visual features associated with similar visual words stored in an index.

Accordingly, in one aspect, the present invention is directed to computer storage media having computer-executable instructions embodied thereon, that when executed, cause a computing device to perform a method for performing a visual word search. The method includes receiving a sketched imaged. The method further includes identifying a dictionary containing definitions for a plurality of visual words. The sketched image is converted into one or more visual words selected from the dictionary. The one or more visual words are compared to an index to determine at least one match. At least one stored image corresponding to the at least one match is identified and displayed.

In another aspect, the present invention is directed to computer storage media having computer-executable instructions embodied thereon, that when executed, cause a computing device to perform a method for creating an index of visual words. The method includes translating visual features from a plurality of stored images into one or more visual words. An index is created comprising the one or more visual words and a reference to each stored image associated with the one or more visual words.

In yet another aspect, the present invention is directed to a method for searching for images. The method includes translating visual features from a plurality of images into visual words associated with a dictionary. The visual words are indexed with at least one reference to the plurality of images. A sketched image is received and utilized to search the plurality of images for similar images. Visual features from the sketched image are translated into sketched image visual words. The index is searched for at least one match with the sketched image visual words. One or more similar images from the plurality of images associated with the at least one match is displayed.

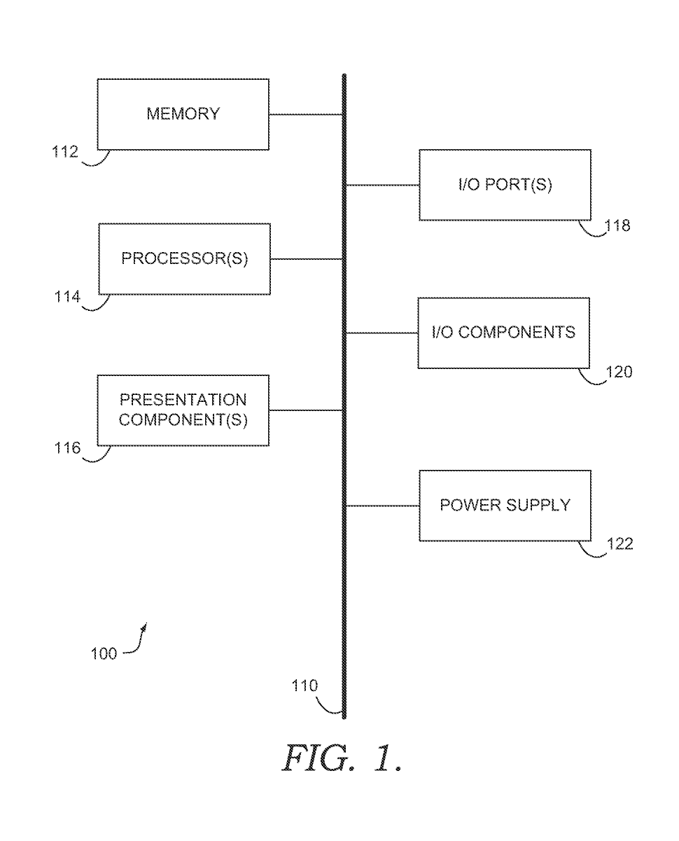

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

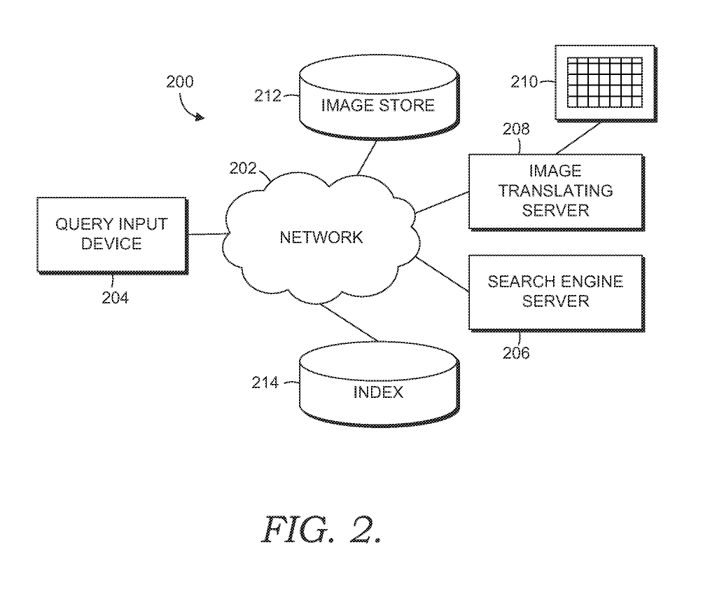

With reference to FIG. 2, a block diagram is illustrated that shows an exemplary computing environment 200 configured for use in implementing embodiments of the present invention. It will be understood and appreciated by those of ordinary skill in the art that the environment 200 shown in FIG. 2 is merely an example of one suitable environment and is not intended to suggest any limitation as to the scope of use or functionality of the present invention. Neither should the environment 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The environment 200 includes a network 202, a query input device 204, and a search engine server 206. The network 202 includes any computer network such as, for example and not limitation, the Internet, an intranet, private and public local networks, and wireless data or telephone networks. The query input device 204 is any computing device, such as the computing device 100, from which a search query can be initiated. For example, the query input device 204 might be a personal computer, a laptop, a server computer, a wireless phone or device, a personal digital assistant (PDA), or a digital camera, among others. In an embodiment, a plurality of query input devices 204, such as thousands or millions of query input devices 204, is connected to the network 202.

The search engine server 206 includes any computing device, such as the computing device 100, and provides at least a portion of the functionalities for providing a content-based search engine. In an embodiment a group of search engine servers 206 share or distribute the functionalities for providing search engine operations to a user population.

An image translating server 208 is also provided in the environment 200. The image translating server 208 includes any computing device, such as computing device 100, and is configured to analyze and translate the visual features associated with an image into visual words. The image translating server 208 further indexes the visual words associated with each stored image as described more fully below. The image translating server 208 includes a dictionary 210 that is stored in a memory of the image translating server 208 or is remotely accessible by the image translating server 208. The dictionary 210 is used by the image translating server 208 to define a plurality of visual words for describing (i.e., translating) the visual features of images and allow for the searching and indexing of visual words associated with the images.

The search engine server 206 and the image translating server 208 are communicatively coupled to an image store 212 and an index 214. The image store 212 and the index 214 include any available computer storage device, or a plurality thereof, such as a hard disk drive, flash memory, optical memory devices, and the like. The image store 212 provides data storage for image files that may be provided in response to a visual word search in an embodiment of the invention. The index 214 provides a visual word search index for identifying images available via network 202, including the images stored in the image store 212. The index 214 may utilize any indexing data structure or format, and preferably employs an inverted index format.

An inverted index provides a data structure storing a mapping from the visual words. The visual words are, in an embodiment, defined by a dictionary 210 to associated images in the image store 212. In an embodiment, the dictionary comprises visual words corresponding to color, shape, position, size, and background. In an embodiment, a visual word comprises an expression of color, shape, position, size, background, or any combination thereof. For example, a user may sketch a small yellow circle in the upper right corner over a blue background. A visual word for that sketch might be a single visual word describing each aspect of the sketch, such as “small yellow circle upper right corner blue background”. However, the visual words for that sketch might be broken into several visual words describing different aspects of the sketch the visual words for that sketch, such as “small yellow circle”, “upper right corner”, and “blue background”. The visual words also might use logic to combine certain visual words, such as “small yellow circle” and “upper right corner” to describe that the sun is in the upper right corner of the image.

When searching for an image associated with a particular visual word, that visual word (or a similar visual word as defined by the dictionary) is found in the inverted index which identifies each image in the image store 212 associated with that visual word. Similarly, when searching for an image associated with more than one visual word, each visual word is found in the inverted index which identifies each image in the image store 212 corresponding to each visual word. In an embodiment, results are ranked according to the images with the most visual words in common with the sketched image (i.e., a stored image with 3 visual words in common with the sketched image is ranked higher than a stored image with 2 visual words in common with the sketched image). In an embodiment, the dictionary defines synonyms for various visual words, such that a query for a specific visual word will identify one or more visual words as a match.

In an embodiment, one or more of the search engine server 206, image processing server 208, image store 212, and index 214 are integrated in a single computing device or are directly communicatively coupled so as to allow direct communication between the devices without traversing the network 202.

Text-based keywords that are associated with other types of input can also be extracted for use. An image file often has metadata associated with the file. This can include the title of the file, a subject of the file, or other text associated with the file. The other text can include text that is part of a document where the media file appears as a link, such as a web page, or other text describing the media file. The metadata associated with an image file can be used to supplement a visual word search in a variety of ways. The text metadata can be used to form additional query suggestions that are provided to a user. The text c-based keywords can also be used automatically to supplement an existing search query, in order to modify the ranking of responsive results. In one embodiment, the index includes the text-based keywords in addition to the visual words. In another embodiment, an index separate from the visual word index includes the text-based keywords.

In addition to using metadata associated with an input query, the metadata associated with a responsive result can be used to modify a search query. For example, a visual word search based on a sketched image may result in a known image of the Eiffel Tower as a responsive result. The metadata from the responsive result may indicate that the Eiffel Tower is the subject of the responsive image result. This metadata can be used to suggest additional queries to a user, or to automatically supplement the search query. This metadata can also be used to rank the responsive image results. The index can also comprise this metadata, along with the visual words defined by the dictionary, to reference the stored images. A separate index can be used for both the metadata and the visual words.

There are multiple ways to extract metadata. The metadata extraction technique may be predetermined or it may be selected dynamically either by a person or an automated process. Metadata extraction techniques can include, but are not limited to: (1) parsing the filename for embedded metadata; (2) extracting metadata from the near-duplicate digital object; (3) extracting the surrounding text in a web page where the near-duplicate digital object is hosted; (4) extracting annotations and commentary associated with the near-duplicate from a web site supporting annotations and commentary where the near-duplicate digital media object is stored; and (5) extracting query keywords that were associated with the near-duplicate when a user selected the near-duplicate after a text query. In other embodiments, metadata extraction techniques may involve other operations.

Some of the metadata extraction techniques start with a body of text and sift out the most concise metadata. Accordingly, techniques such as parsing against a grammar and other token-based analysis may be utilized. For example, surrounding text for an image may include a caption or a lengthy paragraph. At least in the latter case, the lengthy paragraph may be parsed to extract terms of interest. By way of another example, annotations and commentary data are notorious for containing text abbreviations (e.g. IMHO for “in my humble opinion”) and emotive particles (e.g. smileys and repeated exclamation points). IMHO, despite its seeming emphasis in annotations and commentary, is likely to be a candidate for filtering out where searching for metadata.

In the event multiple metadata extraction techniques are chosen, a reconciliation method can provide a way to reconcile potentially conflicting candidate metadata results. Reconciliation may be performed, for example, using statistical analysis and machine learning or alternatively via rules engines.

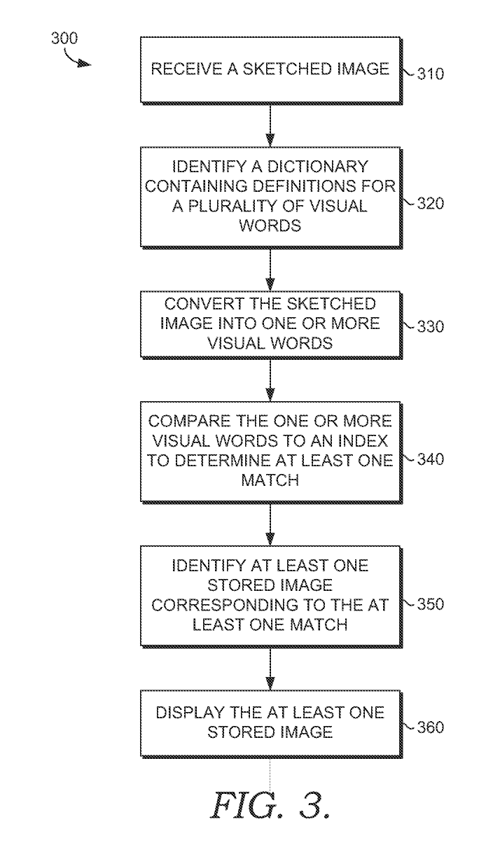

Referring now to FIG. 3, a sketched image is received at step 310. The sketched image allows a user to sketch a rough image of the type of image the user seeks. Once the rough image is translated into visual words, the image store is searched for similar images, as identified by finding images comprising the same or similar visual words as the sketched image. In one embodiment, a selectable palette of colors is presented for sketching a sketched image. A tool is presented for sketching the sketched image with at least one selected color. In another embodiment, a grid sketch area is presented for receiving a sketched image. At least one color is received in at least one section of the grid sketch area. Search terms are provided, in another embodiment, to further identify stored images or refine the results. In one embodiment A dictionary containing definitions for a plurality of visual words is identified at step 320. The sketched image is translated into visual words at step 330. For example, if a user is looking for images of a stop sign, the user might select red from the palette of colors and fill in the grid sketch area with a red octagon. The dictionary, in this example, contains visual words to describe the color “red” and the shape “octagon”. Or, as described above, the visual words may be a combination of words to describe multiple features of the image, such as “red octagon”.

At step 340, the visual words for the sketched image are compared to an index to determine at least one match. Continuing the above example, the index is searched for matches of “red” and/or “octagon” (or “red octagon” as described above; for the purpose of this example, assume color and shape are two separate words, however it is contemplated that they could comprise a single visual word and even include visual features characterizing position, size, background, etc.). At least one stored image is identified at step 350 that corresponds to the at least one match. There may be a number of images in the image store 212 identified by the index 214 associated with either “red” or “octagon”. Each corresponds to a match. The at least one image is displayed at step 360. However, because the displayed images are ranked, in one embodiment, the stored images associated with both “red” and “octagon” will be displayed first because they represent a one hundred percent match to the visual words associated with the sketched image. In one embodiment, the location on the grid sketch area further distinguishes the stored images. For example, continuing the above scenario, assume the user is looking for images containing a stop sign in the lower right corner of the image. In this situation, the user would select the color red, and fill in the grid sketch area with a red octagon in the lower right corner. The dictionary, in this example, contains visual words to describe the color “red”, the shape “octagon”, and the position “lower right corner”. The highest ranked image may be associated with all three visual words. As is evident, the dictionary may contain definitions, in various embodiments, as complex or simplistic as desired and combining descriptive features including size, shape, color, position, and background, or any combination thereof.

In another embodiment, search terms associated with the sketched image are received. Continuing the above example, assume the user sketches a red octagon in the lower right corner of the grid sketch area and inputs a textual query, “stop sign”. In one embodiment, text-based keywords are also stored in the index with the visual words. In another embodiment, text-based keywords are stored in an index separate from the visual word index. In one embodiment, the images identified as including visual words matching one or more visual words associated with the sketched image are then searched for text-based keywords matching the textual query. In one embodiment, the index is searched for both text-based keywords and visual words to identify matches and rank and display the stored images appropriately.

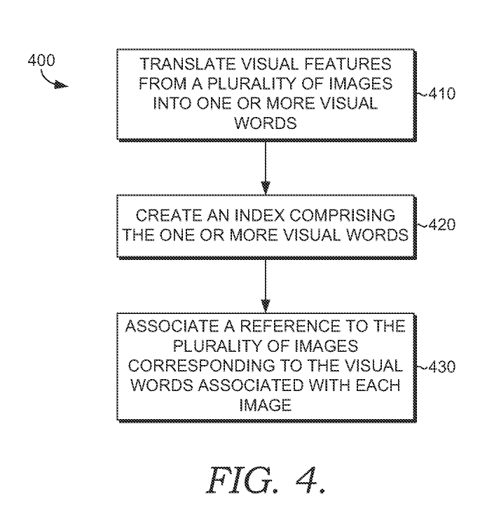

Referring now to FIG. 4, visual features are translated from a plurality of images into one or more visual words at step 410. As discussed above, a dictionary defines the visual words, in one embodiment, to describe the visual features. The plurality of images is discovered, in one embodiment, by a crawler. In one embodiment, the plurality of images are converted to a standard format and stored in an image store. In one embodiment, the standard format is a 160×160 thumbnail. In another embodiment, the standard format is a 200×200 thumbnail. At step 420, an index comprising the one or more visual words associated with the visual features of the plurality of images is created. The visual words comprise color, shape, size, position, background, or any combination thereof for the visual features as defined by the dictionary. At step 430, a reference is associated to the plurality of images corresponding to the visual words associated with each image. For example, “yellow circle” may be a visual word defined by the dictionary. Ten images stored in the image store may be associated with the visual word “yellow circle”. In the index, a reference to each of the ten images is included for the visual word “yellow circle”.

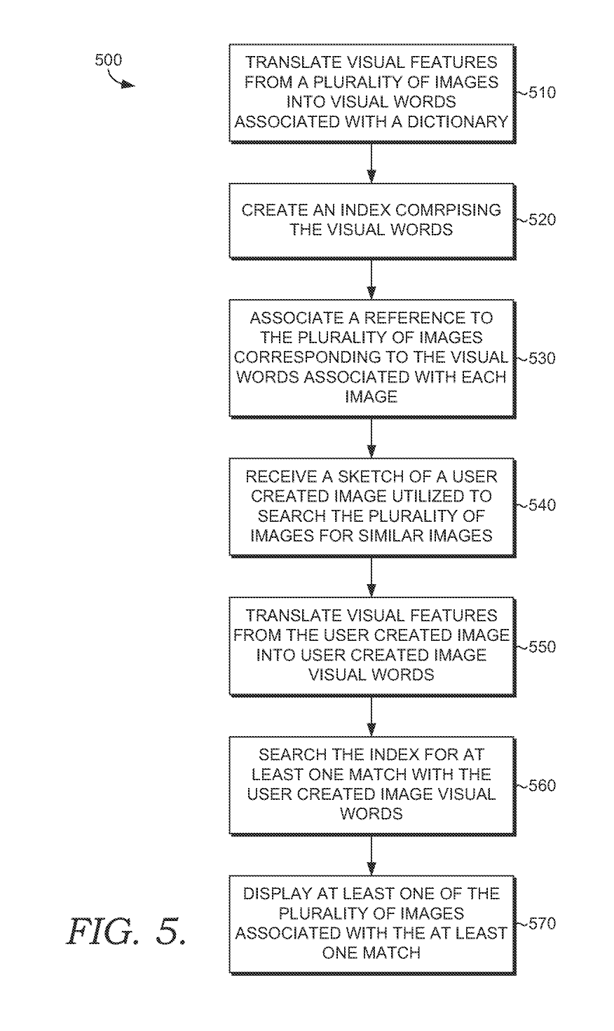

Referring now to FIG. 5, visual features are translated from a plurality of images into one or more visual words at step 510. As discussed above, a dictionary defines the visual words, in one embodiment, to describe the visual features. The plurality of images is discovered, in one embodiment, by a crawler. In one embodiment, the plurality of images are converted to a standard format and stored in an image store. In one embodiment, the standard format is a 160×160 thumbnail. In another embodiment, the standard format is a 200×200 thumbnail. At step 520, an index comprising visual words is created. At step 530, a reference is associated to the plurality of images corresponding to the visual words associated with each image. For example, an image of the sun in the right hand corner of a blue sky may be described by the visual words “yellow circle”, “upper right corner”, and “blue background”. As described above, the dictionary may define visual words with characteristics for color, shape, position, background, size, or any combination thereof. In this example, the visual word is “yellow circle upper right corner blue background”. Each of the visual words resides in the index and includes a pointer to the image described above.

At step 540, a sketched image is received for searching the plurality of images stored in the image store. Continuing the above example, assume a user wants to find images of the sun. The user may select the color yellow from a color palette and fill in the grid sketch area with yellow in the shape of a circle. The sketch is translated, at step 550, into sketched image visual words. In this example, the sketched image may be translated into the visual words “yellow circle”. The index is searched, at step 560, to identify matches between the sketched image visual words and the visual words in the index. In this example, the index is searched to identify at least one match for the sketched image visual words “yellow circle”. At step 570, images that are associated with the at least one match are displayed. In this example, images of tennis balls or the sun may be displayed. As discussed above, the user may also wish to include textual query to refine the results of the search. For example, the user may desire to exclude images of tennis balls, so the user may include “sun” as a textual query. In this instance, the combination of the sketched image query and the textual query identifies images of the sun, or at least ranks images higher that are responsive both queries, rather than responsive to just one of the queries.

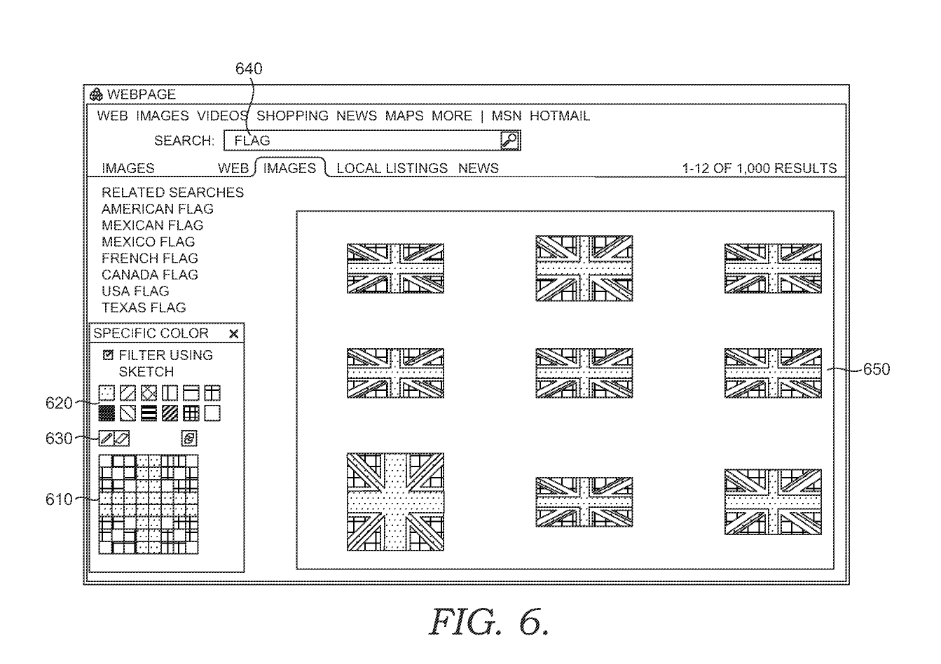

Referring now to FIG. 6, an illustrative screen display of an embodiment of the present invention is shown. A grid sketch area 610 is provided for allowing a user to sketch a drawing to utilize for identifying images in an image store with similar visual features. For example, assume a user is looking for images of a British flag. The user selects the appropriate colors from the color palette 620 and selects the appropriate tool from the tools 630. The user can then sketch the user's interpretation of the British flag, as shown in the grid sketch area 610. The user may also include in the text query box 640 the word “flag”. The results of the query are displayed in the results box 650.

It will be understood by those of ordinary skill in the art that the order of steps shown in the method 300, 400, and 500 of FIGS. 3, 4, and 5 respectively are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. Computer-storage media storing computer-useable instructions, that, when executed by a computing device, perform a method for performing a visual word search, the method comprising:
receiving a sketched image;
identifying a dictionary containing definitions for a plurality of visual words;
converting the sketched image into one or more visual words selected from the dictionary;
comparing the one or more visual words to an index to determine at least one match;
identifying at least one stored image corresponding to the at least one match; and
displaying the at least one stored image.

2. The media of claim 1, further comprising ranking the at least one stored image.

3. The media of claim 1, further comprising:
presenting a selectable palette of colors for sketching a sketched image; and
presenting a tool for sketching a sketched image with at least one selected color.

4. The media of claim 1, wherein receiving a sketched image comprises:
presenting a grid sketch area for receiving a sketched image; and
receiving at least one color in at least one section of the grid sketch area.

5. The media of claim 1, further comprising receiving one or more search terms associated with the sketched image.

6. The media of claim 5, further comprising comparing the one or more search terms to text-based keywords associated with the at least one stored image.

7. The media of claim 6, wherein the text-based keywords words are stored in the index.

8. The media of claim 5, wherein comparing the one or more visual words to an index includes comparing the one or more search terms to the index.

9. Computer-storage media storing computer-useable instructions, that, when executed by a computing device, perform a method for performing a visual word search, the method comprising:
translating visual features from a plurality of stored images into one or more visual words;
creating an index comprising the one or more visual words, wherein each visual word comprises color, shape, size, position, background, or any combination thereof; and
associating a reference to the plurality of images corresponding to the visual words associated with each image.

10. The media of claim 9 further comprising:
receiving a sketched image for searching the plurality of stored images;
translating the sketched image into one or more sketched image visual words;
identifying at least one match between the one or more sketched image visual words and the visual words in the index; and
displaying at least one of the stored images associated with the at least one match.

11. The media of claim 10, further comprising ranking the at least one of the stored images.

12. The media of claim 10, further comprising:
receiving a selection from a palette of colors for sketching a sketched image; and
receiving a selection of a tool for sketching the sketched image with at least one selected color.

13. The media of claim 10, wherein receiving a sketched image comprises
receiving a sketched image in a grid sketch area.

14. The media of claim 10, further comprising receiving one or more search terms associated with the sketched image.

15. The media of claim 14, further comprising comparing the one or more search terms to text based words associated with the at least one stored image.

16. The media of claim 15, wherein the text based words are stored in the index.

17. The media of claim 16, further comprising comparing the one or more search terms to the index to identify at least one textual match.

18. The media of claim 17, wherein displaying at least one of the stored images associated with the at least one match comprises:
identifying at least one stored image associated with the at least one match and the at least one textual match; and
displaying the at least one stored image.

19. A method for searching for images, the method comprising:
translating visual features from a plurality of images into visual words associated with a dictionary;
creating an index comprising the visual words;
associating a reference to the plurality of images corresponding to the visual words associated with each image;
receiving a sketch of a user created image utilized to search the plurality of images for similar images;
translating visual features from the user created image into user created image visual words;
searching the index for at least one match with the user created image visual words; and
displaying one or more similar images from the plurality of images associated with the at least one match.

20. The method of claim 19, wherein searching the index for at least one match further comprises:
identifying at least one match corresponding to each of the visual words;
identifying one or more similar images from the plurality of images associated with the at least one match;
ranking the one or more similar images; and
displaying the one or more similar images according to the ranking.
